(19) United States
(12) Patent Application Publication
(10) Pub. No.: US 2008/0299452 A1
(43) Pub. Date: Dec. 4, 2008

(54) BATTERY PACK

(75) Inventor: Hiroshi Nakazawa, Tokyo (JP)

Correspondence Address: DARBY & DARBY P.C., P.O. BOX 770, Church Street Station, New York, NY, 10008-0770, US

(73) Assignee: DENSEI-LAMBDA K.K., Tokyo (JP)

(21) Appl. No.: 11/756,070

(22) Filed: May 31, 2007

(51) Int. Cl. H01M 6/46

(52) U.S. Cl. 429/152

(57) ABSTRACT

The battery pack is made up by stacking vertically a plurality of electrically-series-connected flat-plate-like battery cells so as to attain a given voltage and a given capacity. Interlayer members are interposed between each battery cell stacked. The interlayer member functions as a surface pressure distributing member to thereby equalize surface pressures of the battery cells building up the battery pack, thus permitting the whole of the battery pack to lengthen in life span. Further, by employing, as the interlayer members, heat insulating members with heat insulating efficiency or heat dissipating members with excellent thermal conductivity, the battery cell located in a central position of the battery pack is prevented from shortening partially in life span, thus permitting the whole of the battery pack to lengthen in life span.

### CROSS-REFERENCE TO RELATED APPLICATION

The present application is related to Japanese Patent Application No. 2005-004392, filed Jan. 11, 2005. The content of the application is incorporated herein by reference in its entirety.

### FIELD OF THE INVENTION

The present invention relates to a battery pack such as that of lithium-ion batteries made available for an electric source utilized for a wide variety of electronic equipment.

### BACKGROUND OF THE INVENTION

In general, in an uninterruptible electric power unit requiring a backup electric source, when an input voltage from a commercial alternating current source is being normally generated, necessary direct-current or alternating voltage is supplied from a main electric source of an electric source body acting as electronic equipment to a load with a secondary battery being charged via the main electric source. On the one hand, when the input voltage has dropped markedly or electric power interruption has occurred, a secondary battery acting as a backup electric source supplies electric power from the main electric source to the load without interruption. The secondary battery utilized here has been conventionally a lead storage battery and the main reason for utilizing the lead battery is that the lead storage battery is inexpensive and besides its charging and discharging behaviors are easy to manage.

FIGS. 3 and 4 are block diagrams representing an outline configuration of the conventional uninterruptible electric power unit. In each of these drawings, numeral symbol 1 denotes an electric power supply circuit that an alternating input voltage Vi, e.g., from the commercial electric source (not shown) is applied to and acts as the main electric source. One or more loads 3 to which an alternating or direct-current output voltage Vo is applied are connected with the electric power supply circuit 1. Numeral symbol 4 denotes the lead storage battery, acting as the backup electric source, which feeds electric power to the load 3 at the time of a drop of the input voltage Vi or electric power interruption. A charging circuit 5 for charging the lead storage battery 4 when the input voltage Vi is normal and a discharging circuit 6 for discharging the lead storage battery 4 to feed electric power to the load 3 at the time of the drop of the input voltage Vi or electric power interruption are each incorporated into the electric power supply circuit 1. Here, FIG. 3 shows an example where the lead storage battery 4 and the electric power supply circuit 1 are each housed inside a main body case 7 acting as an electric power source main body, while FIG. 4 shows an example where the lead storage battery 5 is set separately from the electric power supply circuit 1.

The electric power supply circuit 1 is accordingly incorporated with an AC/AC converter 11 for converting an alternating input voltage Vi into the alternating output voltage Vo required for the load 3, an AC/CD converter 12 for converting an alternating input voltage Vi into an increased or decreased DC voltage, a DC/DC converter 13 for converting the direct-current voltage obtained in the AC/CD converter 12 into the direct-current output voltage Vo required for the load 3 or the like.

And now, in the uninterruptible power supply mounted with the lead storage battery 4, a large battery housing space should be secured of and in addition, its weight becomes extremely heavy and further there occur various environmental issues attributable to using lead. In order to eliminate these defects, e.g., in the patent document Japanese un-examined patent application publication No. 2002-58170, an uninterruptible power supply is proposed which employs a lithium-ion secondary battery in substitute for the lead storage battery. The lithium-ion secondary battery employed described here comprises a battery module (a battery pack) made up from a plurality of battery cells series-connected and is also incorporated with a battery protection circuit for preventing overcharge and over discharge.

Further, in another patent document, Japanese Patent Gazette No. 2,861,879, disclosed are a package-shaped secondary battery pack that is equipped with over discharge and overcharge protection circuits and is incorporated with the lithium-ion secondary batteries.

Such a configuration of the lithium-ion battery pack is shown by FIG. 5. There are cylinder and square types in the lithium-ion battery pack and here the square type is diagrammatically shown. In the figure, a battery pack 20 denotes a battery stack formed by stacking vertically a plurality of flat-plate-like battery cells 21 electrically series-connected. A battery protection circuit 22 is mounted on the uppermost portion of the battery stack. In general, an inside structure of the battery cell 21 is one where cobaltate lithium (LiCoO₂) or manganesate lithium (LiMnO₂) is employed as a positive electrode and graphite are employed as a negative electrode, respectively and further separators are sandwiched between each electrode for insulation and after stacking each electrode plate in some layers, the stacked layers as well as a battery electrolyte are sealed with an aluminum laminate or the like.

### SUMMARY OF INVENTION

There has been, however, the problem that in the existing battery pack, a plurality of the battery cells 21 is stacked to form the battery pack 20 and thereby when each battery cell 21 generates heat in charging or discharging, the heat accumulates in central portion of the battery pack 20 to shorten the life span of the battery pack 20. The lithium-ion battery has a property, e.g., that its use under a high-temperature condition shortens remarkably its own life span. Accordingly, the battery cell located in the central portion of the battery pack 20 is first to end its life ahead of the other cells located apart from the central position, thus decreasing the total voltage of the battery pack 20. Accordingly, the whole of the battery pack 20 should be replaced irrespective of remaining lives of the other battery cells 21.

Further, if some degree of pressure is applied onto a surface of the battery cells 21, the lithium-ion battery, e.g., tends to lengthen in life span due to the resulting good contact from the pressure applied between electrodes and an electrolyte. The electrolyte is, however, in the form of liquid and is gelatinous and so is soft and besides the aluminum laminate acting as a package is soft as well. Accordingly, even if the battery cells 21 whose surfaces are soft are stacked to be subjected to pressure from the outside, surface pressure to each battery cell becomes nonuniform. As a result, the problem has arisen that longer life of the whole of the battery pack 20 could not be expected.

With the view to the problem described above, it is an object of the present invention to lengthen the life span of a battery pack comprising battery bodies.

A first aspect of the present invention is a battery pack where a plurality of battery bodies is stacked. In the battery pack, surface pressure distributing members are interposed between the battery bodies.

Accordingly, since the surface pressures of the whole of the battery bodies building up the battery pack are allowed to be equalized, the whole of the battery pack can lengthen in life span.

A second aspect of the present invention is a battery pack where a plurality of battery bodies is stacked. In the battery pack, heat insulating members are interposed between the battery bodies.

Accordingly, since each battery body building up the battery pack is allowed to be thermally separated by the heat insulating member, battery bodies located in a central portion of the battery pack are prevented from reaching a high temperature caused by heat of the other battery bodies. Accordingly, the battery bodies, eventually the whole of the battery pack can be prevented from shortening in life span to be able to lengthen in life span.

A third aspect of the present invention is a battery pack where a plurality of battery bodies is stacked. In the battery pack, heat dissipating members are interposed between the battery bodies.

Accordingly, since heat generated in each battery body building up the battery pack is rapidly dissipated by the heat dissipating members, the heat doesn't accumulate in a central portion of the battery pack. Accordingly, the battery bodies, eventually the whole of the battery pack can be prevented from shortening in life span to be able to lengthen in life span.

A fourth aspect of the present invention is a battery pack where a plurality of battery bodies is stacked. In the battery pack, a plurality of the heat dissipating members is connected by heat transfer members.

Accordingly, since a heat dissipating area increases by the heat dissipating members to dissipate rapidly heat generated in each battery bodies building up the battery pack and each the heat dissipating member is thermally connected with each other by the heat transfer members. Accordingly, heat of each battery body is equalized to make a life span of each battery cell substantially approximate to each other to prevent the battery bodies, eventually the whole of the battery pack from shortening in life span, thus permitting the life span of the whole of the battery pack to lengthen.

According to the first aspect of the present invention, the surface pressure of each battery cell is allowed to be equalized, thus permitting the whole of the battery pack to lengthen in life span.

According to the second aspect of the present invention, little heat transfer occurs between each battery body to prevent the battery pack from shortening partially in life span, thus permitting the whole of the battery pack to lengthen in life span.

According to the third aspect of the present invention, the heat generated in the central portion of the battery pack is dissipated to prevent the battery pack from shortening partially in life span, thus permitting the whole of the battery pack to lengthen in life span.

According to the fourth aspect of the present invention, heat dissipation of the battery pack can be more effectively performed and besides heat in each battery cell becomes uniform to prevent the battery pack from shortening partially in life span, thus permitting the whole of the battery pack to lengthen in life span.

### BRIEF DESCRIPTION OF THE DRAWING

The invention will be more readily understood by reference to the following description, taken with the accompanying drawings, in which:

FIG. 1 is a longitudinal sectional view illustrating a substantial part of a battery pack in a first embodiment of the present invention.

FIG. 2 is a longitudinal sectional view illustrating a substantial part of a battery pack in a second embodiment of the present invention.

FIG. 3 is a block diagram representing one example of a conventional uninterruptible electric power supply unit using a lead storage battery.

FIG. 4 is a block diagram representing one example of another conventional uninterruptible electric power supply unit using a lead storage battery.

FIG. 5 is a perspective view of a conventional battery pack.

### DESCRIPTION OF THE PREFERRED EMBODIMENTS

The following is a detailed description of preferred embodiments of a battery pack according to the present invention with reference to the appended drawings. In addition, the same numeral symbols are labeled for parts the same as in a conventional example and descriptions of common parts are omitted to avoid overlap in the description.

FIG. 1 is a longitudinal cross-sectional view of a substantial part, representing a configuration of the battery pack in a first embodiment. As a battery cell 21 acting as a battery body building up a battery pack 20, the same lithium-ion battery as shown in the conventional example is employed. More specifically, an inside of the battery cell 21 is e.g., so structured that each of positive and negative electrode plates and each of separators are stacked in some layers and then the stacked layers together with an electrolyte are sealed by an aluminum laminate or the like. In the present embodiment, the battery pack 20 is built by stacking vertically a plurality of electrically-series-connected flat-plate-like battery cells so as to attain a predetermined voltage and a given capacity, while interlayer members 25 are interposed between each of the battery cells 21 stacked.

The interlayer member 25 is intended to equalize surface pressure of the battery cell 21 and may take any form, such as e.g., a plate-like one or a grid-like (mesh-like) one as long as the surface pressure of the battery cell 21 is equalized when pressure is allowed to exert on the battery pack from the outside. Further, a material of the interlayer member 25 may be any one, e.g., such as a hard member like metal, an elastic member like rubber, low-elastic urethane or the like provided that the material bears moderate hardness and its surficial form is deformed in conformity to a form of the battery cell 21,

When pressurizing, e.g., the battery pack 20 from its outside by pressing the battery pack 20 into a casing, the battery cell 21 with a comparatively soft surface is compressed to each of the comparatively hard interlayer members 25, so that the battery cell 21 is attached firmly to the interlayer member 25 of the battery cell 21, Accordingly distributing the surface pressure of the battery cell 21. In other word, the interlayer member 25 functions as a surface pressure distributing member to equalize the surface pressure of the battery cell 21. Thus, by making up the battery pack 20 by interposing the interlayer members 25 between each of a plurality of the battery cells 21, the surface pressures of the battery cells 21 building up the battery pack 20 are equalized, thereby permitting the whole of the battery pack 20 to lengthen in life span.

Meanwhile, as indicated above, the battery cells 21 generates heat in charging and discharging and therefore the heat generated accumulates in the central portion of the battery pack 20 to thereby shorten the life span of the battery pack 20. As a means for constraining this life span shortening, the present invention employs, as the interlayer member 25, a heat insulating member with heat insulation efficiency or a heat dissipating member with excellent thermal conductivity.

When employing the heat insulating member as the interlayer member 25, each battery cell 21 building up the battery pack 20 is thermally separated by the interlayer member 25 interposed between each battery cell 21. Accordingly, even if each battery cell 21 generates heat in charging and discharging, little heat transfer arises between each battery cell 21 and therefore it can be prevented that one battery cell 21 is heated by heat generated by the other battery cell 21 to rise to a temperature higher than that resulting from self-heating. One battery cell 21 located in the central portion of the conventional battery pack 20 is heated from the upside and the downside thereof by heat generated by the other battery cell 21, whereas in the battery pack of the present invention, the heat generated by the other battery cells 21 is blocked by interposing the interlayer members 25 with the heat insulation efficiency between each battery cell 21. As a result, the one battery cell 21 is prevented from reaching a high temperature due to an influence by the heat generated by the other battery cells 21, so that the battery cell 21, eventually the whole of the battery pack 20 can be restrained from shortening in life span to be able to lengthen in life span.

On the contrary, when the heat dissipating member is employed as the interlayer member 25, the heat generated by each battery cell 21 building up the battery pack 20 is rapidly dissipated by the interlayer member 25 interposed between each battery cell 21. Accordingly, even if each battery cell 21 generates the heat in charging and discharging, the heat is rapidly dissipated, thus permitting an inside of the battery pack 20 to be prevented from reaching a high temperature. Since the battery pack 20 has a structure where a plurality of the battery cells 21 is stacked, the heat tends to accumulate in the central portion of the battery pack 20. The heat generated by the battery cells 21 is, however, rapidly dissipated by interposing the interlayer members 25 excellent in heat dissipation capability between each battery cell 21. As a result, little heat accumulate in the central portion of the battery pack 20, thus permitting the battery cells 21, eventually the battery pack 20 to lengthen in life span.

In this case, due to poor heat dissipation performance in the central portion of the battery pack 20 and in the upper and lower areas thereof, heat generated by each battery cell 21 is prone to remain inside the portions, thus tending to raise the temperatures in the portions and the areas higher than those in the other portions. In consideration of the tendency, as an interposing method of the heat dissipation member, particularly thicker heat dissipation members are interposed between the layers in the central portion and in the upper and lower portions thereof to increase the heat dissipation effect and further due to the resulting wider spacing between the battery cells, the central portion can be prevented from rising higher in temperature than does the surrounding portions. Thus, it is effective for lengthening the life span of the battery pack 20 to take measures to make the temperatures of the whole area of the battery pack approximate uniformity.

As stated above, in the present embodiment, there is provided a battery pack 20 where a plurality of battery cells 21 acting as battery bodies is stacked. In the battery pack 20, interlayer members 25 are interposed between the battery cells 21 as a surface pressure distributing member.

Accordingly, since the surface pressures of the battery cells 21 building up the battery pack 20 are equalized, the whole of the battery pack 20 can lengthen in life span.

Further, in the present embodiment, there is provided a battery pack 20 where a plurality of battery cells 21 is stacked. In the battery pack 20, interlayer members 25 are interposed between the battery cells 21 as a heat insulating member.

Accordingly, since each battery cell that builds up the battery pack 20 is allowed to be thermally separated by the interlayer member 25, the battery cell 21 located in a central portion of the battery pack 20 is prevented from reaching a high temperature exerted by an influence of heat of the other battery cells 21. Accordingly, the battery cell 21, eventually the whole of the battery pack 20 can be prevented from shortening in life span to be able to lengthen in life span. Consequently, little heat transfer occur between each battery cell 21 to prevent the battery pack 20 from partially shortening in life span, thus permitting the whole of the battery pack 20 to lengthen in life span.

Furthermore, in the present embodiment, there is provided a battery pack 20 where a plurality of battery cells 21 is stacked. In the battery pack 20, interlayer members 25 are interposed between the battery cells 21 as a heat dissipating member.

Accordingly, the heat generated in each battery cell 21 building up the battery pack 20 is dissipated by the interlayer members 25 excellent in heat dissipating capability. As a result, little heat accumulates in the central portion of the battery pack 20, thus permitting the battery cells 21, eventually the battery pack 20 to lengthen in life span. Consequently, the heat in the central portion of the battery pack 20 is dissipated to prevent the battery pack 20 from partially shortening in life span, thus permitting the whole of the battery pack 20 to lengthen in life span.

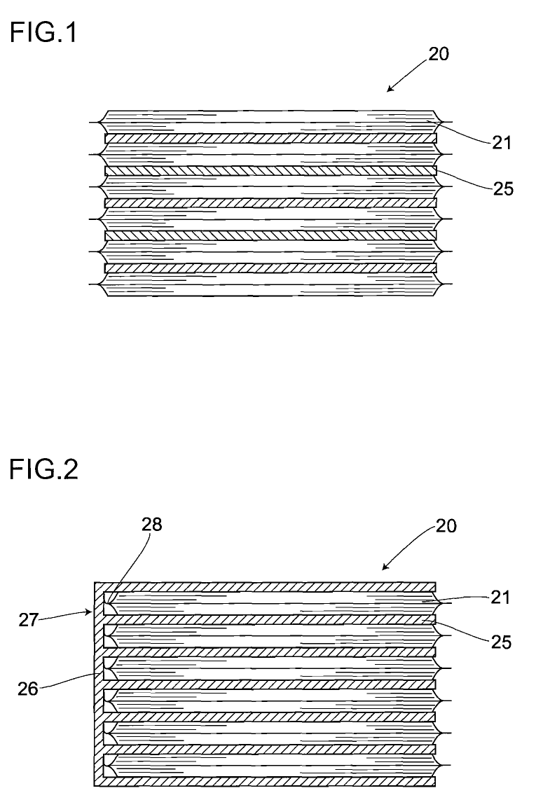

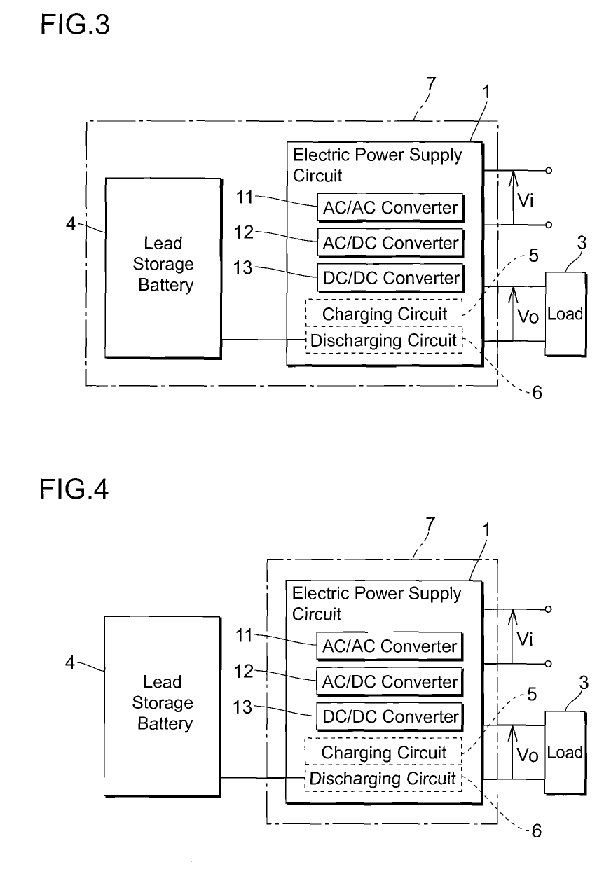

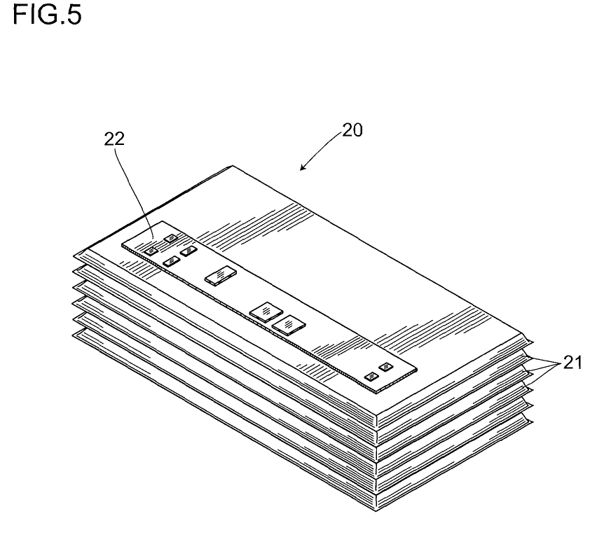

FIG. 2 is a cross-sectional view of a substantial part, representing a battery pack in a second embodiment. A basic structure of a battery pack 20 is approximately the same as that of the lithium-ion battery shown in the first embodiment. Specifically, the battery pack 20 has a form of a battery stack made up by stacking vertically a plurality of electrically-series-connected flat-plate-like battery cells so as to attain a given voltage and a given capacity, while interlayer members 25 are interposed between each battery cell 21. Interlayer members 25 employed in the present embodiment are interposed not only between each battery cell 21 but also in the uppermost and lowermost portions, thus sandwiching vertically each battery cell 21 by a plurality of the interlayer members 25.

A heat dissipating member with excellent thermal conductivity is employed as an interlayer member 25 in the present embodiment, while each interlayer member 25 is coupled together by a thermally conductive member 26 with excellent conductivity like the above. The interlayer member 25 and the thermally conductive member 26 are integrally molded by using, e.g., an aluminum die-casting method or the like to form a casing 27 as an outer envelope member of the battery pack 20. The casing 27 has a form where an inside of an U-shaped outer envelop member formed by two interlayer members 25 that are located in the uppermost and lowermost positions and by the thermal conductive member 26 is partitioned by a plurality of the interlayer members 25. Each battery cell 21 is pressed into each battery cell room 28 that is a space produced by the partition.

In the present embodiment, since the interlayer members 25 are coupled by the thermally conductive member 26, a heat dissipating area is markedly increased. So, even if each battery cell 21 generates heat in charging and discharging, the heat is rapidly transferred to allow an inside of the battery pack 20 to be prevented from getting up to a high temperature. Further, since each interlayer member 25 is interconnected thermally by the thermally conductive member 26, the heat generated by each battery cell 21 is equalized to thereby make a life span of each battery cell 21 substantially approximate to each other and thereby the battery cell 21, eventually the whole of the battery pack 20 is prevented from shortening in life span, thus permitting the life span to lengthen. In particular, in the present embodiment, the interlayer member 25 and the thermally conductive member 26 form the casing 27 to make each battery cell 21 to be pressed into the battery cell room 28 partitioned by the interlayer member 25. Accordingly, the battery cell 21 can be pressurized so as to equalize the surface pressure of the battery cell 21.

In the present embodiment as stated above, a plurality of the interlayer members 25 excellent in heat dissipation capability is coupled by the thermally conductive member 26.

Accordingly, the heat dissipation area increases due to the thermally conductive member 26 to dissipate rapidly the heat generated by each battery cell 21 building up the battery pack 20 and further each interlayer member 25 is thermally connected by the thermally conductive member 26. Accordingly, the heat of each battery cell 21 is equalized to approximate substantially the life span of each battery cell 21, thus enabling the battery cell 21, eventually the whole of the battery pack 20 to be prevented from shortening in life span. Consequently, the heat of the battery pack 20 can be more effectively dissipated and besides the heat in each battery cell 21 is equalized to thereby prevent the battery pack 20 from partially shortening in life span, thus permitting the whole of the battery pack 20 to lengthen in life span.

In addition, the present invention is not limited to the embodiments described above and various modifications are possible within the scope of the gist of the present invention. Not limiting to the lithium-ion battery as a battery pack of the present invention, various battery packs possessed of the same properties and problems can fall within the application of the present invention. Further, the interlayer member 25 may be interposed not between each layer of each battery cell 21 but between each of a plurality of the battery cells such as each of two or three battery cells. A heat dissipating interlayer member 25 (a heat dissipating plate) and a heat insulating interlayer member 25 (a heat insulating plate) may be combined together. For example, one unit (a constituent) may be formed where a plurality of the battery cells 21 is sandwiched by two sheets of the heat dissipating plates and then when a plurality of these units is stacked, the heat insulating plates may be interposed between the heat dissipating plates.

1. A battery pack comprising a plurality of battery bodies stacked, wherein surface pressure distributing members for equalizing surface pressures of said battery bodies are interposed between said battery bodies whose surfaces are soft.

2. A battery pack according to claim 1, wherein said surface pressure distributing member is a net-like member.

3. A battery pack according to claim 1, wherein said surface pressure distributing member is an elastic member.

4. A battery pack according to claim 1, wherein said surface pressure distributing member is a member made from a low-elastic urethane.

5. A battery pack according to claim 1, wherein said surface pressure distributing member is interposed between each of said battery bodies.

6. A battery pack according to claim 1, wherein said surface pressure distributing member is interposed between each of a plurality of said battery bodies.

7. A battery pack according to claim 1, wherein heat insulating members with heat insulation property are employed for said surface pressure distributing members so that no heat transfer occurs between said battery bodies.

8. A battery pack according to claim 7, wherein said heat insulating member is interposed between each of said battery bodies.

9. A battery pack according to claim 7, wherein said heat insulating member is interposed between each of a plurality of said battery bodies.

10. A battery pack according to claim 1, wherein heat dissipating members with heat dissipating capability are employed for said surface pressure distributing members.

11. A battery pack according to claim 10, wherein a plurality of said heat dissipating members is coupled by heat transfer members.

12. A battery pack according to claim 10, wherein said heat dissipating member is interposed between each of said battery bodies.

13. A battery pack according to claim 10, wherein said heat dissipating member is interposed between each of a plurality of said battery bodies.
